(19) United States
(12) Patent Application Publication
(10) Pub. No.: US 2004/0081043 A1
(43) Pub. Date: Apr. 29, 2004

(54) Optical disk device and optical splitting device

(75) Inventors: Seiji Nishiwaki, Kobe-shi (JP); Youichi Saitoh, Hirakata-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/685,714

(22) Filed: Oct. 14, 2003

(30) Foreign Application Priority Data
Oct. 18, 2002 (JP) 2002-304913

(51) Int. Cl. G11B 7/095

(52) U.S. Cl. 369/44.41

(57) ABSTRACT

The present invention provides an optical disk device and an optical splitter in each of which even if an objective lens and a polarization hologram substrate deviate in a disk radial direction, off-track does not occur under tracking control, and two radiation light sources can simultaneously be handled in the case of employing a configuration with two radiation light sources. Light emitted from a radiation light source is reflected by a signal plane of an optical disk, and passes through an objective lens to enter an optical splitter. The optical splitter is divided into four quadrants Ak (wherein k=1, 2, . . . ) by two straight lines that intersect with an optical axis. The photodetector is divided into at least four regions Bk. First-order diffracted lights ak are derived from light that has entered the quadrants Ak by the optical splitter and are projected on the regions Bk of the photodetector, respectively. Sections of the first-order diffracted lights a2 and a3 taken along the x-axis lie approximately on a boundary between the regions B2 and B3. The first-order diffracted lights a1 and a4 are distributed on the photodetector apart from each other.

### BACKGROUND OF THE INVENTION

1. Field of the Invention

The present invention relates generally to an optical disk device and an optical splitting device that are used for recording signals on an optical disk or reproducing signals recorded on an optical disk.

2. Related Background Art

The conventional technique is described in, for example, JP2000-133929A. Based on this precedent with a part thereof being modified, the following description is made with reference to FIGS. 9 to 10B. FIG. 9 shows a cross-sectional configuration of an optical disk device according to the conventional example, and includes a side view of a radiation light source 1 and the vicinity thereof, which is added below the diagram showing the cross-sectional configuration. In FIG. 9, a laser beam emitted from the radiation light source 1 such as a semiconductor laser or the like attached to a photodetection substrate 9 is reflected by a reflecting mirror 10 attached to the photodetection substrate 9, and is converted into parallel light through a collimator lens 4. The parallel light passes through a polarization hologram substrate 2, and is converted from linearly polarized light (a S wave or a P wave) to circularly polarized light through a quarter-wave plate 3, which then is converged by an objective lens 5 to be focused on a signal plane 6a of an optical disk substrate 6. The light reflected by the signal plane 6a passes through the objective lens 5, and is converted into linearly polarized light (a P wave or a S wave) through the quarter-wave plate 3, which then enters a hologram plane 2a inside the polarization hologram substrate 2 to be diffracted and branched into first-order diffracted light 8 and minus first-order diffracted light 8′ that are symmetrical to each other with respect to an optical axis 7 serving as the symmetry axis. The first-order diffracted light 8 and minus first-order diffracted light 8′ pass through the collimator lens 4 whereby the respective diffracted lights become convergent lights, which then are incident on a detection plane 9a of the photodetection substrate 9. The quarter-wave plate 3 is disposed on the same substrate as that on which the hologram plane 2a is provided, and moves together with the objective lens 5. The detection plane 9a is located approximately at the position of a focal plane of the collimator lens 4 (i.e. the position of a virtual light emission point of the light source 1).

FIGS. 10A and 10B show the configurations of a photodetection plane and a hologram plane of the optical disk device according to the conventional example, respectively. In FIGS. 10A and 10B, both the photodetection plane and the hologram plane are seen from the optical disk side. The point 20 indicates a point of intersection of the hologram plane 2a and the optical axis 7. The hologram plane 2a is divided into four quadrants by two straight lines (an X-axis and a Y-axis) that are orthogonal to each other at the point 20. Furthermore, each quadrant is divided into strip regions 21B, 21F, 22B, 22F, 23B, 23F, 24B, and 24F arranged along the X-axis.

On the other hand, the point 90 is a point of intersection of the detection plane 9a and the optical axis 7. The two straight lines that are orthogonal to each other at point 90 and are parallel to the X-axis and Y-axis are indicated as an x-axis and a y-axis. Comb-tooth-like focus detector cells F1a, F2a, F1b, F2b, F1c, F2c, F1d, F2d, F1e, and F2e are arranged along the y-axis on the plus side of the y-axis. Trapezoidal tracking detector cells 7T1, 7T2, 7T3, and 7T4 are disposed on the minus side of the y-axis. These detector cells are arranged to be symmetrical in shape with respect to the y-axis. The light emitted from the emission point 1a of the radiation light source 1 travels in parallel with the x-axis in the plane that is orthogonal to the paper surface and that intersects with the x-axis, and is reflected by the reflecting mirror 10 in the direction of the optical axis i.e. the direction orthogonal to the paper surface through the point 90).

First-order diffracted lights 81B and 81F diffracted through the comb-tooth-like regions 21B and 21F in the first quadrant of the hologram plane 2a are focused on light spots 81BS and 81FS that are formed astride the border between the detector cells F2a and F1b, respectively, and minus first-order diffracted lights 81B′ and 81F′ are focused on light spots 81BS′ and 81FS′ that are formed on the detector cell 7T1 alone, respectively. First-order diffracted lights 82B and 82F diffracted through the comb-tooth-like regions 22B and 22F in the second quadrant are focused on light spots 82BS and 82FS that are formed astride the border between the detector cells F1b and F2b, respectively, and minus first-order diffracted lights 82B′ and 82F′ are focused on light spots 82BS′ and 82FS′ that are formed on the detector cell 7T2 alone, respectively. First-order diffracted lights 83B and 83F diffracted through the comb-tooth-like regions 23B and 23F in the third quadrant are focused on light spots 83BS and 83FS that are formed astride the border between the detector cells F1d and F2d, respectively, and minus first-order diffracted lights 83B′ and 83F′ are focused on light spots 83BS′ and 83FS′ that are formed on the detector cell 7T3 alone, respectively. First-order diffracted lights 84B and 84F diffracted through the comb-tooth-like regions 24B and 24F in the fourth quadrant are focused on light spots 84BS and 84FS that are formed astride the border between the detector cells F2d and F1e, respectively, and minus first-order diffracted lights 84B′ and 84F′ are focused on light spots 84BS′ and 84FS′ that are formed on the detector cell 7T4 alone, respectively. Since the first-order diffracted lights 81B, 82B, 83B, and 84B are focused on the back side of the detection plane 9a (i.e. on the further side from the hologram plane 2a), the light spots formed on the detection plane 9a are similar in form to the light distribution on the hologram plane 2a. Since the minus first-order diffracted lights 81B′, 82B′, 83B′, and 84B′ are focused on the front side of the detection plane 9a (i.e. on the side nearer to the hologram plane 2a), the light spots formed on the detection plane 9a are similar in form to a light distribution obtained by inverting the light distribution on the hologram plane 2a with respect to the point 20. Since the first-order diffracted lights 81F, 82F, 83F, and 84F are focused on the front side of the detection plane 9a, the light spots formed on the detection plane 9a are similar in form to a light distribution obtained by inverting the light distribution on the hologram plane 2a with respect to the point 20. Moreover, since the minus first-order diffracted lights 81F′, 82F′, 83F′, and 84F′ are focused on the back side of the detection plane 9a, the light spots formed on the detection plane 9a are similar in form to the light distribution on the hologram plane 2a.

Some of the detector cells are electrically connected, and as a result, the following six signals can be obtained.

F1=a signal obtained in the detector cell F1a+a signal obtained in the detector cell F1b+a signal obtained in the detector cell F1c+a signal obtained in the detector cell F1d+a signal obtained in the detector cell F1e

F2=a signal obtained in the detector cell F2a+a signal obtained in the detector cell F2b+a signal obtained in the detector cell F2c+a signal obtained in the detector cell F2d+a signal obtained in the detector cell F2e

T1=a signal obtained in the detector cell 7T1

T2=a signal obtained in the detector cell 7T2

T3=a signal obtained in the detector cell 7T3

T4=a signal obtained in the detector cell 7T4

In FIGS. 10A and 10B, with the y-axis indicating the radial direction of the optical disk 6, a focus error signal FE that indicates an error in focusing light on the optical disk signal plane, a tracking error signal TE that indicates an error in tracking an optical disk track, a reproduction signal RF that is reproduced from the optical disk signal plane are detected based on the following formulae.

FE=F1−F2 Formula 1

TE=T1+T2−T3−T4 Formula 2

RF=F1+F2+T1+T2+T3+T4 Formula 3

Such a conventional optical disk device has the following problems. Generally, the TE signal according to Formula 2 can be expressed by the following formula using suitable coefficients a and b, wherein Δ denotes the amount of off-track with respect to the optical disk track, and δ indicates the deviation in the disk radial direction (i.e. the Y-axis direction), of the objective lens 5 and the polarization hologram substrate 2.

TE=aΔ+bδ Formula 4

That is, as in the conventional example, when using the TE detection method according to Formula 2, offset occurs as the objective lens 5 and the polarization hologram substrate 2 that moves together therewith deviate in the disk radial direction (this deviation inevitably occurs under tracking control). The reason why the signal TE is the function of δ is as follows: the uneven intensity distribution of the light emitted from the radiation light source 1 that is stronger near the optical axis and is weaker as the distance from the optical axis increases causes the intensity distribution of the returned light 80 on the hologram plane 2a to be asymmetric with respect to the X-axis due to the deviation of the objective lens 5 and the polarization hologram substrate 2 in the radial direction. In the case of optical disks, such as DVD-RAM, etc., with deep guide grooves (having an optical depth D of, for example, about λ/6, wherein λ denotes the wavelength of the light source) and a wide pitch (for instance, a groove pitch Λ of about 1.21 to 1.48 μm), since the diffraction effect provided by the grooves allows the intensity distribution of the returned light 80 on the hologram plane 2a to be approximately uniform in the Y-axis direction, the coefficient b is approximately zero (i.e. substantially b=0), which causes no problem. However, in the case of optical disks, such as DVD-R, DVD-RW, etc., with shallow guide grooves (having an optical depth D of, for example, about λ/10 to λ/20) and a narrow pitch (for instance, a groove pitch Λ of about 0.74 μm), the coefficient b is not zero (i.e. b≠0) due to the aggravated asymmetry of the returned light 80.

Generally, the tracking control is performed to make the signal TE zero (i.e. TE=0). Hence, when b≠0, an amount of off-track:

Δ=−bδ/a Formula 5

occurs according to Formula 4.

As an example, with respect to a disk with a groove depth D of λ/12 and a groove pitch Λ of 0.74 μm, b/a=about 2.4/10000, and an amount of off-track Δ of 0.048 μm occurs when δ=200 μm. This amount is large and cannot be ignored in the disk with a track pitch of 0.74 μm. This may cause track skipping, deterioration in reproduced signals, deterioration in adjacent track signals in recording, etc.

### SUMMARY OF THE INVENTION

In order to solve the aforementioned conventional problems, the present invention is intended to provide an optical disk device in which even if an objective lens and a polarization hologram substrate deviate in a disk radial direction, off-track does not occur under tracking control. It also is an object of the present invention to provide an optical disk device and an optical splitting device that each can simultaneously handle two radiation light sources disposed to be adjacent to each other on a photodetection substrate.

In order to achieve the above-mentioned object, a first optical disk device of the present invention includes a radiation light source, an objective lens, an optical splitter, and a photodetector. Light emitted from the radiation light source passes through the objective lens to be focused on a signal plane of an optical disk. Light reflected by the signal plane passes through the objective lens to enter the optical splitter. The optical splitter is divided into four quadrants Ak (wherein k=1, 2, 3, 4) by two straight lines (a y-axis parallel with an optical disk radial direction and an x-axis orthogonal thereto) that intersect with an optical axis. The photodetector is divided into at least four regions Bk. First-order diffracted lights ak are derived from light that has entered the quadrants Ak by the optical splitter and are projected on the regions Bk of the photodetector, respectively. Sections of the first-order diffracted lights a2 and a3 taken along the x-axis lie approximately on a boundary between the regions B2 and B3. The first-order diffracted lights al and a4 are distributed on the photodetector apart from each other.

It is preferable that a tracking error signal TE with respect to the optical disk is generated according to a formula of TE=C1−C4−(C2−C3)/m, where Ck denotes a signal detected in the region Bk (wherein k=1, 2, 3, or 4), and m indicates a suitable value of 1 or higher.

It is preferable that minus first-order diffracted lights ak′(wherein k=1, 2, 3, 4) are derived from light that has entered the quadrants Ak by the optical splitter, the minus first-order diffracted light a2′ is focused on a detection plane without being inverted with respect to a substantial y-axis direction, and the minus first-order diffracted light a3′ is inverted with respect to the substantial y-axis direction to be focused on the detection plane.

A second optical disk device according to the present invention includes a first radiation light source, a second radiation light source, an objective lens, an optical splitter, and a photodetector. The first and second radiation light sources are disposed on the photodetector. Light emitted from the first radiation light source passes through the objective lens to be focused on a signal plane of a first optical disk. Light reflected by the signal plane passes through the objective lens to enter the optical splitter. The optical splitter is divided into four quadrants Ak (wherein k=1, 2, 3, 4) by two straight lines (a y-axis parallel with an optical disk radial direction and an x-axis orthogonal thereto) that intersect with an optical axis. The photodetector is divided into at least four regions Bk. First-order diffracted lights ak are derived from light that has entered the quadrants Ak by the optical splitter and are projected on the regions Bk of the photodetector, respectively. Light that is emitted from the second radiation light source and has a different wavelength from that of the light emitted from the first radiation light source passes through the objective lens to be focused on a signal plane of a second optical disk. Light reflected by the signal plane of the second optical disk passes through the objective lens to enter the optical splitter, and first-order diffracted lights bk are derived from light that has entered the quadrants Ak by the optical splitter and are projected on the regions Bk of the photodetector, respectively.

It is preferable that sections of the first-order diffracted lights a2 and a3, or b2 and b3 taken along the x-axis lie approximately on a boundary between the regions B2 and B3, and the first-order diffracted lights a1 and a4, or b1 and b4 are distributed on the photodetector apart from each other.

It is preferable that a tracking error signal TE with respect to the first or second optical disk is generated according to a formula of TE=C1−C4−(C2−C3)/m, where Ck denotes a signal detected in the region Bk (wherein k=1, 2, 3, or 4), and m indicates a suitable value of 1 or higher.

It also is preferable that minus first-order diffracted lights ak′ or bk′ (wherein k=1, 2, 3, 4) are derived from light that has entered the quadrants Ak by the optical splitter, the minus first-order diffracted light a2′ or b2′ is focused on a detection plane without being inverted with respect to a substantial y-axis direction, and the minus first-order diffracted light a3′ or b3′ is inverted with respect to the substantial y-axis direction to be focused on the detection plane.

Furthermore, an optical disk device and an optical splitting device according to the present invention each include a first radiation light source, a second radiation light source, an objective lens, an optical splitter, and a photodetector. The optical splitter has a configuration with a birefringent medium having a periodic concave-convex cross-section. Light having a wavelength λ1 emitted from the first radiation light source enters the optical splitter to be converted into light having a phase difference of about 2nπ (where n is an integral number other than zero) periodically. The light passes through the objective lens to be focused on a signal plane of a first optical disk. Light reflected by the signal plane passes through the objective lens and then enters the optical splitter to be converted into light having a phase difference of about 2nπ+ζ (where α denotes a real number other than zero) periodically, and diffracted light derived from the light enters the photodetector to be detected. Light having a wavelength λ2 emitted from the second radiation light source enters the optical splitter to be converted into light having a phase difference of about 2nπ−λ1/λ2 periodically. The light passes through the objective lens to be focused on a signal plane of a second optical disk. Light reflected by the signal plane of the second optical disk passes through the objective lens and then enters the optical splitter to be converted into light having a phase difference of about (2nπ+α)λ1/λ2 periodically. Diffracted light derived from the light enters the photodetector to be detected.

With the above-mentioned configurations, off-track that occurs under the tracking control can be cancelled. Furthermore, in the configuration with two adjacent radiation light sources, control signals and reproduction signals corresponding to the lights emitted from the respective light sources are detected by the same photodetector, and off-track that occurs under the tracking control can be cancelled. Particularly, with respect to one light source, the diffraction efficiency can never be zero under any birefringence conditions given for the optical disk substrate and thereby optical disk signals can be detected reliably.

### BRIEF DESCRIPTION OF THE DRAWINGS

FIG. 1 is a cross-sectional view showing the configuration of an optical disk device according to Embodiment 1 of the present invention.

FIGS. 2A and 2B show the configurations of a detection plane and a hologram plane of the optical disk device according to Embodiment 1 of the present invention, respectively.

FIGS. 3A to 3C show diagrams illustrating the positions of focal points located before and behind a photodetector in the cross-section taken along an optical axis when a focal point on a signal plane of an optical disk is focused, according to Embodiment 1 of the present invention; FIG. 3A shows the case of first-order diffracted lights 81B, 84B, 81F, and 84F, and minus first-order diffracted lights 81B′, 84B′, 81F′, and 84F′; FIG. 3B the case of first-order diffracted light 82 and minus first-order diffracted light 82′; and FIG. 3C the case of first-order diffracted light 83 and minus first-order diffracted light 83′.

FIGS. 4A and 4B are diagrams illustrating a photodetection pattern and the manner of light distributed thereon, and a hologram pattern according to Embodiment 2 of the present invention, respectively.

FIG. 5 is a cross-sectional view showing the configuration of an optical disk device according to Embodiment 3 of the present invention.

FIG. 6 is a cross-sectional view showing the configurations of a polarization hologram 2 and a quarter-wave plate 3 according to Embodiment 3 of the present invention.

FIG. 7A is a cross-sectional view showing the configuration of another example of a polarization hologram according to Embodiment 3 of the present invention; and FIG. 7B is a cross-sectional view showing the configuration of a further example of a polarization hologram according to Embodiment 3 of the present invention.

FIGS. 8A and 8B are diagrams each showing a photodetection pattern and the manner of light distributed thereon according to Embodiment 3 of the present invention.

FIG. 9 is a cross-sectional view showing the configuration of an optical disk device according to a conventional example.

FIGS. 10A and 10B show the configurations of a detection plane and a hologram plane of the optical disk device according to the conventional example, respectively.

### DETAILED DESCRIPTION OF THE INVENTION

The present invention is characterized in that light emitted from a radiation light source passes through an objective lens to be focused on a signal plane of an optical disk, the light reflected by the signal plane is divided into four, with two of them separated and the other two are made to lie on the joint between photodetectors. A differential signal is detected from each pair, and these differential signals are calculated to detect a tracking error (TE) signal. With this, the present invention can provide an optical disk device in which off-track does not occur under tracking control even if the objective lens and a polarization hologram substrate deviate in a disk radial direction. Furthermore, the present invention can provide an optical disk device and an optical splitter that each can simultaneously handle two radiation light sources disposed to be adjacent to each other on a photodetection substrate.

### EMBODIMENT 1

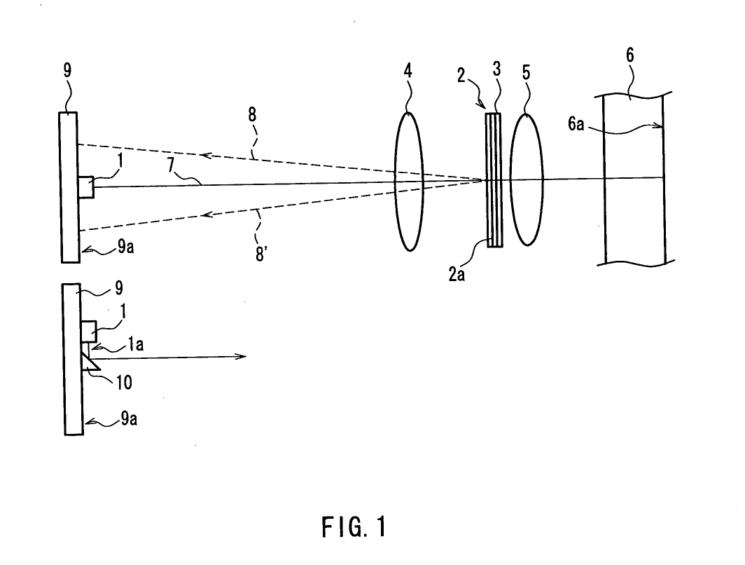

Embodiment 1 of the present invention is described with reference to FIGS. 1 to 3C as follows. The elements common to Embodiment 1 and the conventional example are indicated with the same numerals and characters as those used for describing the conventional example. FIG. 1 shows the cross-sectional configuration of the optical disk device according to Embodiment 1, and includes a side view of a radiation light source 1 and the vicinity thereof, which is added below the diagram showing the cross-sectional configuration. In FIG. 1, a laser beam emitted from the radiation light source 1 such as a semiconductor laser or the like attached to a photodetection substrate 9 is reflected by a reflecting mirror 10 attached to the photodetection substrate 9, and is converted into parallel light through a collimator lens 4. The parallel light passes through a polarization hologram substrate 2 that is an optical splitter, and is converted from linearly polarized light (a S wave or a P wave) to circularly polarized light through a quarter-wave plate 3, which then is converged by an objective lens 5 to be focused on a signal plane 6a of an optical disk substrate 6. The light reflected by the signal plane 6a passes through the objective lens 5, and is converted into linearly polarized light (a P wave or a S wave) through the quarter-wave plate 3, which then enters a hologram plane 2a inside the polarization hologram substrate 2 to be diffracted and branched into first-order diffracted light 8 and minus first-order diffracted light 8′ that are symmetrical to each other with respect to the optical axis 7 serving as the symmetry axis. The first-order diffracted light 8 and minus first-order diffracted light 8′ pass through the collimator lens 4 whereby the respective diffracted lights become convergent lights, which then are incident on a detection plane 9a of the photodetector 9. The quarter-wave plate 3 is disposed on the same substrate as that on which the hologram plane 2a is provided, and moves together with the objective lens 5. The detection plane 9a is located approximately at the position of a focal plane of the collimator lens 4 (i.e. the position of a virtual light emission point of the light source 1). In the hologram 2, the diffraction efficiency for the returned light is, for example, about 0% in the case of zeroth-order light and about 41% in the case of the respective ± first-order lights.

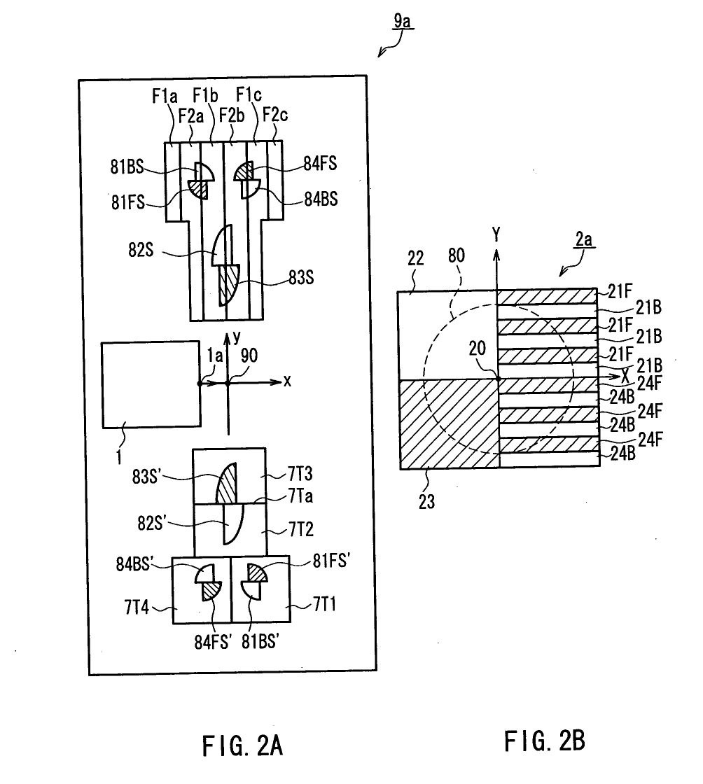

FIGS. 2A and 2B show the configurations of the photodetection plane and the hologram plane of the optical disk device according to Embodiment 1, respectively. In FIGS. 2A and 2B, both the photodetection plane and the hologram plane are seen from the optical disk side. The point 20 indicates a point of intersection of the hologram plane 2a and the optical axis 7. The hologram plane 2a is divided into four quadrants by two straight lines (an X-axis and a Y-axis) that are orthogonal to each other at the point 20. Furthermore, the first quadrant and the fourth quadrant of the four are divided into strip regions 21B, 21F, 24B, and 24F arranged along the X-axis, and the second quadrant and the third quadrant are indicated as a region 22 and a region 23, respectively.

On the other hand, the point 90 is the point of intersection of the detection plane 9a and the optical axis 7. Two straight lines that are orthogonal to each other at point 90 and are parallel to the X-axis and Y-axis are indicated as an x-axis and a y-axis. Comb-tooth-like focus detector cells F1a, F2a, F1b, F2b, F1c, and F2c are arranged along the y-axis on the plus side of the y-axis. Rectangular tracking detector cells 7T1, 7T2, 7T3, and 7T4 are disposed on the minus side of the y-axis. These detector cells are arranged to be symmetrical in shape with respect to the y-axis. The light emitted from the emission point 1a of the radiation light source 1 travels in parallel with the x-axis in the plane that is orthogonal to the paper surface and that intersects with the x-axis, and then is reflected by the reflecting mirror 10 in the direction of the optical axis (i.e. the direction orthogonal to the paper surface through the point 90).

First-order diffracted lights 81B and 81F diffracted through the comb-tooth-like regions 21B and 21F in the first quadrant of the hologram plane 2a are focused on light spots 81BS and 81FS that are formed astride the border between the detector cells F2a and F1b, respectively, and minus first-order diffracted lights 81B′ and 81F′ are focused on light spots 81BS′and 81FS′ that are formed on the detector cell 7T1 alone, respectively. First-order diffracted light 82 and minus first-order diffracted light 82′ that are diffracted through the second quadrant region 22 are focused on a light spot 82S that is formed astride the border between the detector cells F1b and F2b and a light spot 82S′ that is formed on the detector cell 7T2 alone, respectively. First-order diffracted light 83 and minus first-order diffracted light 83′ that are diffracted through the third quadrant region 23 are focused on a light spot 83S that is formed astride the border between the detector cells F1b and F2b and a light spot 83S′ that is formed on the detector cell 7T3 alone, respectively. First-order diffracted lights 84B and 84F diffracted through the comb-tooth-like regions 24B and 24F in the fourth quadrant are focused on light spots 84BS and 84FS that are formed astride the border between the detector cells F2b and F1c, respectively, and minus first-order diffracted lights 84B′ and 84F′ are focused on light spots 84BS′ and 84FS′ that are formed on the detector cell 7T4 alone, respectively.

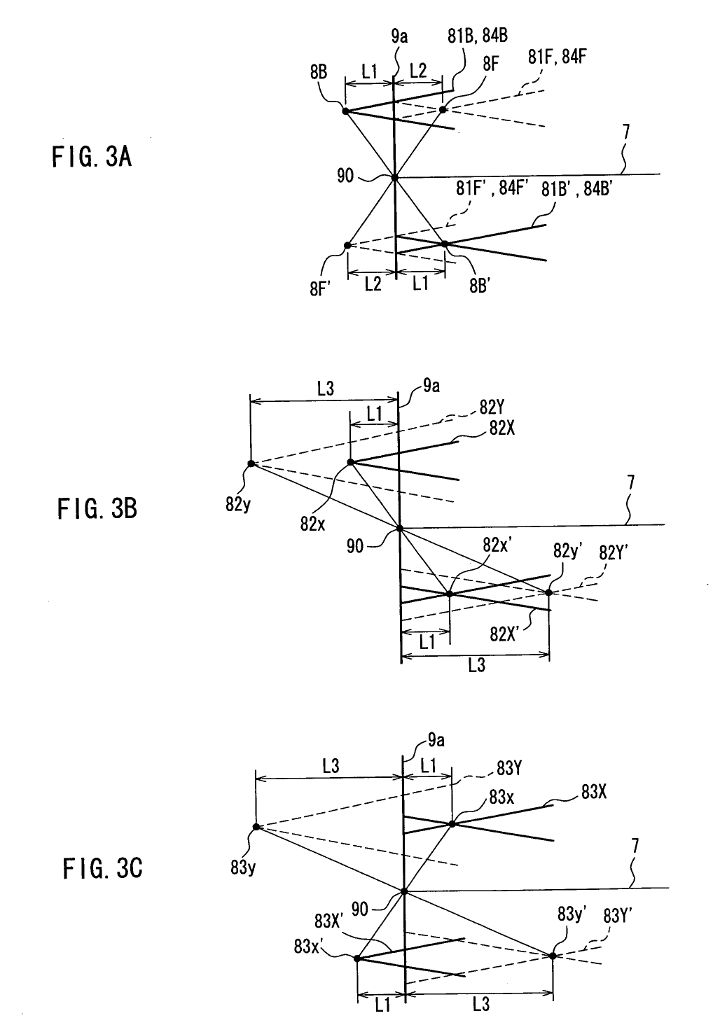

FIGS. 3A to 3C are diagrams illustrating the positions of focal points before and behind the photodetection plane 9a in the cross-section taken along the optical axis according to Embodiment 1 when a focal point on the signal plane 6a of the optical disk is focused; FIG. 3A shows the case of the first-order diffracted lights 81B, 84B, 81F, and 84F, and the minus first-order diffracted lights 81B′, 84B′, 81F′, and 84F′; FIG. 3B the case of the first-order diffracted light 82 and the minus first-order diffracted light 82′; and FIG. 3C the case of the first-order diffracted light 83 and the minus first-order diffracted light 83′. The zeroth-order diffraction component corresponding to each diffracted light is focused on the point 90 on the detection plane 9a, but in practice, light irradiation does not occur since the diffraction efficiency for the zeroth-order light is substantially zero.

As shown in FIG. 3A, with respect to the light 80 diffracted through the hologram plane 2a, the first-order diffracted lights 81B and 84B diffracted in the first and fourth quadrants, respectively, are focused on the point 8B located at a distance L1 from the detection plane 9a on the back side thereof, and the minus first-order diffracted lights 81B′ and 84B′ are focused on the point 8B′ located at a distance L1 from the detection plane 9a on the front side thereof (the paths of the lights are indicated with solid lines). Furthermore, with respect to the light 80 diffracted through the hologram plane 2a, the first-order diffracted lights 81F and 84F diffracted in the first and fourth quadrants, respectively, are focused on the point 8F located at a distance L2 from the detection plane 9a on the front side thereof, and the minus first-order diffracted lights 81F′ and 84F′ are focused on the point 8F′ located at a distance L2 from the detection plane 9a on the back side thereof (the paths of the lights are indicated with dotted lines). The distance L2 is approximately equal to the distance L1.

As shown in FIG. 3B, with respect to the light 80 diffracted through the hologram plane 2a, the first-order diffracted light 82 diffracted through the second quadrant has focal points in the cross-section parallel to the paper surface and in the cross-section orthogonal to the paper surface that are different from each other. In the cross-section orthogonal to the paper surface, it is focused on the point 82x located at a distance L1 from the detection plane 9a on the back side thereof (this diffracted light is indicated as 82X). In the cross-section parallel to the paper surface, it is focused on the point 82y located at a distance L3 from the detection plane 9a on the back side thereof (this diffracted light is indicated as 82Y). On the other hand, the minus first-order diffracted light 82′ diffracted through the second quadrant has focal points in the cross-section parallel to the paper surface and the cross-section orthogonal to the paper surface that are different from each other. In the cross-section orthogonal to the paper surface, it is focused on the point 82x′ located at a distance L1 from the detection plane 9a on the front side thereof (this diffracted light is indicated as 82X′). In the cross-section parallel to the paper surface, it is focused on the point 82y′ located at a distance L3 from the detection plane 9a on the front side thereof (this diffracted light is indicated as 82Y′).

As shown in FIG. 3C, with respect to the light 80 diffracted through the hologram plane 2a, the first-order diffracted light 83 diffracted through the third quadrant has focal points in the cross-section parallel to the paper surface and in the cross-section orthogonal to the paper surface that are different from each other. In the cross-section orthogonal to the paper surface, it is focused on the point 83x located at a distance L1 from the detection plane 9a on the front side thereof (this diffracted light is indicated as 83X). In the cross-section parallel to the paper surface, it is focused on the point 83y located at a distance L3 from the detection plane 9a on the back side thereof (this diffracted light is indicated as 83Y). On the other hand, the minus first-order diffracted light 83′ diffracted through the third quadrant has focal points in the cross-section parallel to the paper surface and in the cross-section orthogonal to the paper surface that are different from each other. In the cross-section orthogonal to the paper surface, it is focused on the point 83x′ located at a distance L1 from the detection plane 9a on the back side thereof (this diffracted light is indicated as 83X′). In the cross-section parallel to the paper surface, it is focused on the point 83y′ located at a distance L3 from the detection plane 9a on the front side thereof (this diffracted light is indicated as 83Y′).

With reference to FIGS. 2, 3A, 3B, and 3C, since the first-order diffracted lights 81B and 84B are focused on the back side of the detection plane 9a (i.e. on the further side from the hologram plane 2a), the light spot formed on the detection plane 9a is similar in form to the light distribution on the hologram plane 2a. Since the minus first-order diffracted lights 81B′ and 84B′ are focused on the front side of the detection plane 9a (i.e. on the side nearer to the hologram plane 2a), the light spot formed on the detection plane 9a is similar in form to a light distribution obtained by inverting the light distribution on the hologram plane 2a with respect to the point 20. Since the first-order diffracted lights 81F and 84F are focused on the front side of the detection plane 9a, the light spot formed on the detection plane 9a is similar in form to a light distribution obtained by inverting the light distribution on the hologram plane 2a with respect to the point 20. Since the minus first-order diffracted lights 81F′ and 84F′ are focused on the back side of the detection plane 9a, the light spot formed on the detection plane 9a is similar in form to the light distribution on the hologram plane 2a. Furthermore, since the first-order diffracted light 82 is focused on the back side of the detection plane 9a in both the cross-sections that are parallel and orthogonal to the paper surface, the light spot on the detection plane 9a is similar in form to a light distribution obtained by expanding the light distribution on the hologram plane 2a in the Y direction. Since the minus first-order diffracted light 82′ is focused on the front side of the detection plane 9a in both the cross-sections that are parallel and orthogonal to the paper surface, the light spot on the detection plane 9a is similar in form to a light distribution obtained by inverting the light distribution on the hologram plane 2a with respect to the point 20 and expanding it in the Y-axis direction. Moreover, since the first-order diffracted light 83 is focused on the front side of the detection plane 9a in the cross-section orthogonal to the paper surface and on the back side of the detection plane 9a in the cross-section parallel to the paper surface, the light spot on the detection plane 9a is similar in form to a light distribution obtained by inverting the light distribution on the hologram plane 2a about the Y-axis and expanding it in the Y-axis direction. Since the minus first-order diffracted light 83′ is focused on the back side of the detection plane 9a in the cross-section orthogonal to the paper surface and on the front side of the detection plane 9a in the cross-section parallel to the paper surface, the light spot on the detection plane 9a is similar in form to a light distribution obtained by inverting the light distribution on the hologram plane 2a about the X-axis and expanding it in the Y-axis direction. The whole light spots 81BS′ and 81FS′ and the whole light spots 84BS′ and 84FS′ are formed within the photodetectors 7T1 and 7T4, respectively. The light spots 82S′ and 83S′, however, are joined to each other in the y-axis direction, and the joint therebetween approximately coincides with the parting line 7Ta between the photodetectors 7T2 and 7T3, which is one characteristic. In addition, it is another characteristic that the light spot 82S has a shape formed without inverting the light distribution on the hologram plane 2a about the Y-axis, while the light spot 83S has a shape formed by inverting it about the Y-axis.

Some of the detector cells are electrically connected, and as a result, the following six signals can be obtained.

F1=a signal obtained in the detector cell F1a+a signal obtained in the detector cell F1b+a signal obtained in the detector cell F1c

F2=a signal obtained in the detector cell F2a+a signal obtained in the detector cell F2b+a signal obtained in the detector cell F2c

T1=a signal obtained in the detector cell 7T1

T2=a signal obtained in the detector cell 7T2

T3=a signal obtained in the detector cell 7T3

T4=a signal obtained in the detector cell 7T4

In FIGS. 2A and 2B, with the y-axis indicating the radial direction of the optical disk 6, a focus error signal FE that indicates an error in focusing light on the optical disk signal plane, a tracking error signal TE that indicates an error in tracking an optical disk track, a reproduction signal RF that is reproduced from the optical disk signal plane are detected based on the following respective formulae.

FE=F1−F2 Formula 6

TE=(T1−T4)−(T2−T3)/m Formula 7

RF=F1+F2+T1+T2+T3+T4 Formula 8

Generally, the manner of light spots formed on the photodetection plane when defocus occurs on an optical disk depends on the relative position relationship between the photodetection plane 9a and the focal point of each spot. The FE signal particularly depends on the spot shape in the x direction. This shape is determined by the relative position relationship between the photodetection plane 9a and the focal point of each light spot in the cross-section orthogonal to the paper surface shown in FIGS. 3A to 3C.

The light spots 82FS and 83BS in the conventional example are formed in the same manner as that in which the light spots 83FS and 82BS are formed when defocus occurs on an optical disk. Hence, even if the light spots 82FS and 83BS are not formed, the FE signal has the same characteristics as those obtained when the light spots 82FS and 83BS are formed. The width of light spots 81BS, 81FS, 82S, 83S, 84BS, and 84FS in the x-axis direction in Embodiment 1 is the same as that of the light spots 81BS and the like in the x-axis direction in the conventional example. When defocus occurs on the optical disk, the light spots 81BS, 81FS, 84BS, and 84FS, therefore, are formed in the same manner as in the conventional example. Accordingly, the light spots 82S and 83S are formed in the same manner as that in which the light spots 82BS and 82FS are formed in the conventional example, respectively, since the position relationship between the photodetection plane 9a and the focal points in the cross-section orthogonal to the paper surface is the same (i.e. the light spots 82S and 83S expand in the y-axis direction as compared to the light spots 82BS and 83FS, but the characteristics of the FE signal do not vary since the manner concerning the FE detection depends on their width in the x-axis direction). Consequently, the characteristics of the FE signal in Embodiment 1 is the same as those in the conventional example.

With respect to off-track, the signal (T1−T4) and the signal (T2−T3) are basically identical to each other, but they also have different characteristics. For instance, the signal (T1−T4) can be expressed by the following formula using the same coefficients a and b as those used in the conventional example, wherein Δ denotes the amount of off-track with respect to an optical disk track, and δ indicates the deviation in the disk radial direction (the Y-axis direction), of the objective lens 5 and the polarization hologram substrate 2 that moves together with the objective lens 5.

T1−T4=aΔ+bδ Formula 9

On the other hand, the signal (T2−T3) can be expressed by the following formula.

T2−T3=aΔ+b′δ Formula 10

The reason why the signal (T1−T4) is the function of δ is as follows: as in the conventional example, the uneven intensity distribution of the light emitted from the radiation light source 1 that is stronger near the optical axis and is weaker as the distance from the optical axis increases causes the intensity distribution of the returned light 80 on the hologram plane 2a to be asymmetric with respect to the X-axis due to the deviation of the objective lens 5 and the polarization hologram substrate 2 in the radial direction. On the other hand, the reason why the dependency of the signal (T2−T3) on δ is different from that of the signal (T1−T4) on δ(i.e. b′≠b) is that there is an influence that the light spots on the detection plane 9a are shifted in the y-axis direction corresponding to the deviation of the objective lens 5 and the polarization hologram substrate 2 in the radial direction, in addition to the intensity distribution of the returned light 80 on the hologram plane 2a that is asymmetric with respect to the X-axis. That is, since the light spots 81BS′ and 81FS′ and the light spots 84BS′ and 84FS′ are formed within the photodetectors 7T1 and 7T4, respectively, the shift of the light spots in the y-axis direction does not cause the shift in amount of light (which is the same as in the conventional example). The light spots 82S′ and 83S′, however, are joined to each other in the y-axis direction and the joint therebetween approximately coincides with the parting line between the photodetectors 7T2 and 7T3. Consequently, when these spots are shifted in the y-axis direction together, the shift in amount of light occurs on both sides of the parting line.

In the case of optical disks, such as DVD-RAM, etc., with deep guide grooves (having an optical depth D of, for example, about λ/6, wherein λ denotes the wavelength of the light source) and a wide pitch (for instance, a groove pitch Λ of about 1.21 to 1.48 μm), since the diffraction effect provided by the grooves allows the intensity distribution of the returned light 80 on the hologram plane 2a to be approximately uniform in the Y-axis direction, the coefficient b is approximately zero (i.e. substantially b=0). In this case, when the coefficient m=∞, i.e. TE=(T1−T4), the amount of off-track is zero under the tracking control (TE=0).

In the case of optical disks, such as DVD-R, DVD-RW, etc., with shallow guide grooves (having an optical depth D of, for example, about λ/10 to λ/20) and a narrow pitch (for instance, a groove pitch Λ of about 0.74 μm), the coefficient b is not zero (i.e. b≠0) due to the aggravated asymmetry of the returned light 80. If the coefficient m in Formula 7 is set to satisfy the formula of m=b′/b, the following formula is derived from Formulae 7, 9, and 10:

TE=(1−1/m)aΔ Formula 11.

Hence, the influence of the deviation δ of the objective lens 5 and the polarization hologram substrate 2 that moves together therewith is eliminated almost perfectly. Even if the deviation δ occurs, off-track is not caused (i.e. zero) under the tracking control (TE=0).

The value of a coefficient ratio of b′/b substantially depends on the optical system and the shape of grooves of the optical disk. In the case of optical disks such as DVD-R and DVD-RW, the coefficient b′ is larger than b by a factor of about 2 to 4. In the above-mentioned embodiment, the light spots 82S′ and 83S′ are described as spots joined to each other in the y-axis direction. There, however, is no change in the effect of eliminating the influence of deviation δ even if those light spots shift in the x-axis direction to be separated from each other. When the position of the emission point 1a shifts in the y-axis direction, the joint between the light spots 82S′ and 83S′ deviates from the parting line 7Ta between the photodetectors 7T2 and 7T3. Accordingly, an amount of offset is added to the signal (T2−T3), but this component can be eliminated through initial learning. Furthermore, even if the position of the emission point 1a shifts in the y-axis direction, since the light spots 82S′ and 83S′ extend in the y-axis direction, the ratio of the deviation amount to the spot diameter can be kept small and thereby an increased margin for this deviation is provided. Moreover, it is described above that the photodetection plane 9a is located at the position of the focal plane of the collimator lens 4, but it may be located in the vicinity of the focal plane. In addition, the light source and the photodetectors are disposed on the same substrate in Embodiment 1 but may be disposed separately.

### EMBODIMENT 2

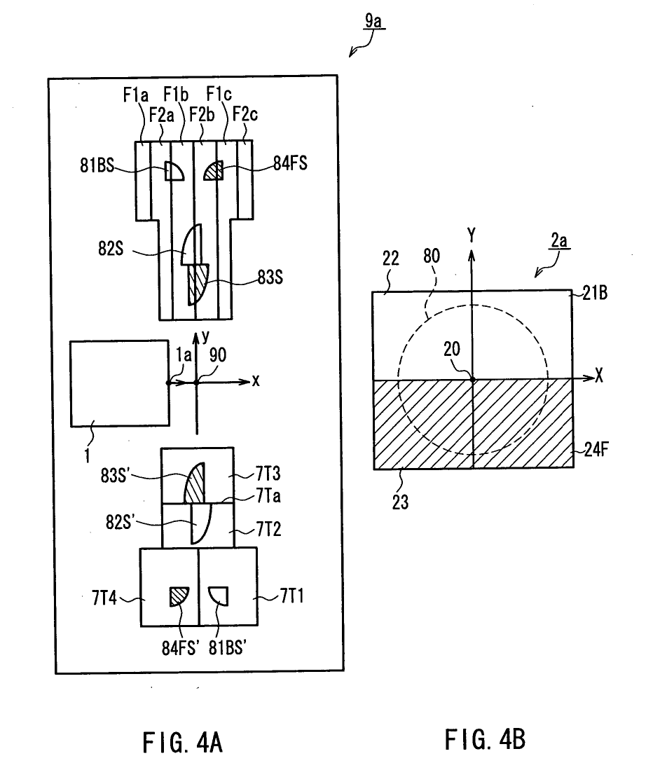

Embodiment 2 of the present invention is described with reference to FIGS. 4A and 4B as follows. Embodiment 2 is the same as Embodiment 1 except for the pattern of the polarization hologram plane 2a, a detection pattern on the photodetector plane 9a, and light distribution thereon. The descriptions of the same parts as those described in Embodiment 1 are omitted here. In the following description, the elements identical to those used in Embodiment 1 are described using the same numerals as those used in Embodiment 1. FIGS. 4A and 4B show the photodetection pattern and the manner of the light distribution thereon, and the hologram pattern in Embodiment 2, respectively, wherein both the photodetection plane (FIG. 4A) and the hologram plane (FIG. 4B) are seen from the side of the optical disk.

With the point of intersection of the hologram plane 2a and the optical axis 7 being indicated as a point 20, the hologram plane 2a is divided into four quadrants by two straight lines (an X-axis and a Y-axis) that are orthogonal to each other at the point 20. The first, second, third, and fourth quadrants are a region 21B, a region 22, a region 23, and a region 24F, respectively.

The point of intersection of the detection plane 9a and the optical axis 7 is indicated as a point 90. Two straight lines that are orthogonal to each other at point 90 and are parallel to the X-axis and the Y-axis are indicated as an x-axis and a y-axis. Comb-tooth-like focus detector cells F1a, F2a, F1b, F2b, F1c, and F2c are disposed along the y-axis on the plus side of the y-axis. Rectangular tracking detector cells 7T1, 7T2, 7T3, and 7T4 are disposed on the minus side of the y-axis. These detector cells are arranged to be symmetrical in shape with respect to the y-axis. The light emitted from the emission point 1a of the radiation light source 1 travels in parallel with the x-axis in the plane that is orthogonal to the paper surface and that intersects with the x-axis, and then is reflected by the reflecting mirror 10 in the direction of the optical axis (i.e. the direction orthogonal to the paper surface through the point 90).

First-order diffracted light 81B and minus first-order diffracted light 81B′ that are diffracted through the first quadrant 21B of the hologram plane 2a are focused on a light spot 81BS that is formed astride the border between the detector cells F2a and F1b and a light spot 81BS′ that is formed on the detector cell 7T1 alone, respectively. First-order diffracted light 82 and minus first-order diffracted light 82′ that are diffracted through the second quadrant region 22 are focused on a light spot 82S that is formed astride the border between the detector cells F1b and F2b and a light spot 82S′ that is formed on the detector cell 7T2 alone, respectively. First-order diffracted light 83 and minus first-order diffracted light 83′ that are diffracted through the third quadrant region 23 are focused on a light spot 83S that is formed astride the border between the detector cells F1b and F2b and a light spot 83S′ that is formed on the detector cell 7T3 alone, respectively. First-order diffracted light 84F and minus first-order diffracted light 84F′ that are diffracted through the fourth quadrant region 24F are focused on a light spot 84FS that is formed astride the border between the detector cells F2b and F1c and a light spot 84FS′ that is formed on the detector cell 7T4 alone, respectively.

The positions of focal points before and behind the photodetector in the cross-section taken along the optical axis when a focal point on a signal plane 6a of an optical disk is focused are the same as those in Embodiment 1 and are identical to those shown in FIGS. 3A to 3C excluding the first-order diffracted lights 81F and 84B and the minus first-order diffracted lights 81F′ and 84B′. Accordingly, FIG. 3A corresponds to the case of the first-order diffracted lights 81B and 84F and the minus first-order diffracted lights 81B′ and 84F′ in the present embodiment; FIG. 3B corresponds to the case of the first-order diffracted light 82 and the minus first-order diffracted light 82′ in the present embodiment; and FIG. 3C corresponds to the case of the first-order diffracted light 83 and the minus first-order diffracted light 83′ in the present embodiment.

The light spots 81FS and 84BS in Embodiment 1 are formed in the same manner as that in which the light spots 84FS and 81BS are formed when defocus occurs on an optical disk. Consequently, even if the light spots 81FS and 84BS are not formed, the FE signal has the same characteristics as those obtained when the light spots 81FS and 84BS are formed. Embodiment 2 corresponds to Embodiment 1 with the light spots 81FS and 84BS being omitted. It therefore is obvious that the same effect as that obtained in Embodiment 1 can be obtained by the same principle as in Embodiment 1 with respect to the deviation of the objective lens 5 and the polarization hologram substrate 2 in the radial direction.

### EMBODIMENT 3

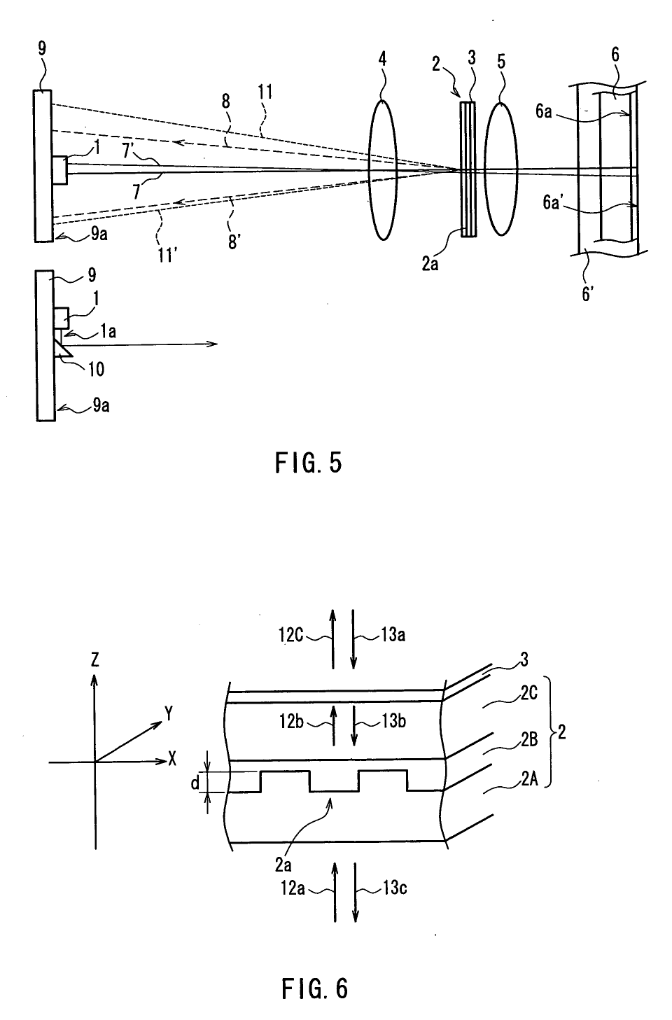

Hereinafter, Embodiment 3 of the present invention is described with reference to FIGS. 5 to 8B. Embodiment 3 is the same as Embodiment 1 except for the number of emission points of the light source increasing from one to two, the modified configuration of the polarization hologram substrate 2 that is an optical splitter, the pattern of the polarization hologram plane 2a, a detection pattern on the photodetection plane 9a, and light distribution thereon. The descriptions of the parts common to Embodiments 1 and 3 are omitted here, and the elements common to Embodiments 1 and 3 are described using the same numerals as those used in Embodiment 1.

FIG. 5 shows the cross-sectional configuration of an optical disk according to Embodiment 3, and includes a side view of a radiation light source 1 and the vicinity thereof, which is added below the diagram showing the cross-sectional configuration. In FIG. 5, a first laser beam (with a wavelength A1) emitted from a first emission point 1a of the radiation light source 1 such as a semiconductor laser or the like attached to a photodetection substrate 9 is reflected by a reflecting mirror 10 attached to the photodetection substrate 9, and is converted into parallel light through a collimator lens 4. The parallel light passes through a polarization hologram substrate 2 and is converted from linearly polarized light (a S wave or a P wave) to circularly polarized light through a quarter-wave plate 3, which then is converged by an objective lens 5 to be focused on a signal plane 6a of a first optical disk substrate 6. The light reflected by the signal plane 6a passes through the objective lens 5, and is converted into linearly polarized light (a P wave or a S wave) through the quarter-wave plate 3, which then enters a hologram plane 2a inside the polarization hologram substrate 2 to be diffracted and branched into first-order diffracted light 8 and minus first-order diffracted light 8′ that are symmetrical to each other with respect to the optical axis 7 serving as the symmetry axis. The first-order diffracted light 8 and minus first-order diffracted light 8′ pass through the collimator lens 4 whereby the respective diffracted lights become convergent lights, which then are incident on a detection plane 9a of the photodetector 9. The quarter-wave plate 3 is disposed on the same substrate as that on which the hologram plane 2a is provided, and moves together with the objective lens 5. The detection plane 9a is located approximately at the position of a focal plane of the collimator lens 4 (i.e. the position of a virtual light emission point of the emission point 1a). The diffraction efficiency for the returned light provided by the hologram plane 2a is, for example, about 0% in the case of zeroth-order light and about 41% in the case of the respective ±first-order lights.

The radiation light source 1 can emit light with a different wavelength from that of the first laser beam. A second laser beam (with a wavelength λ2, wherein λ2>λ1) emitted from a second emission point 1a′ of the radiation light source 1 is reflected by the reflecting mirror 10 attached to the photodetection substrate 9, and is converted into parallel light through the collimator lens 4. The parallel light is transmitted through the polarization hologram substrate 2, and is converted from linearly polarized light (a S wave or a P wave) to elliptically polarized light through the quarter-wave plate 3, which then is converged by the objective lens 5 to be focused on a signal plane 6a′ of a second optical disk substrate 6′. The light reflected by the signal plane 6a′ passes through the objective lens 5, passes through the quarter-wave plate 3, and enters the hologram plane 2a inside the polarization hologram substrate 2 to be diffracted and branched into first-order diffracted light 11 and minus first-order diffracted light 11′ that are symmetrical to each other with respect to an optical axis 7′ serving as the symmetry axis. The first-order diffracted light 11 and minus first-order diffracted light 11′ pass through the collimator lens 4 whereby the respective diffracted lights become convergent lights, which then are incident on the detection plane 9a of the photodetector 9. The optical disk substrate 6 is a disk with a low birefringence such as DVD or the like while the optical disk substrate 6′ is a disk with a high birefringence such as a CD or the like.

FIG. 6 shows cross-sectional configurations of the polarization hologram substrate 2 and the quarter-wave plate 3 according to Embodiment 3. The polarization hologram substrate 2 has a configuration with a birefringence medium 2B being interposed between transparent substrates 2A and 2C having a uniform refractive index (the refractive index of the transparent substrate 2A is indicated by “na”). A grating with a depth d is formed at the surface of the transparent substrate 2A facing the medium 2B. The quarter-wave plate 3 that serves as a quarter-wave plate with respect to the light with a wavelength λ1 is laminated on the surface of the substrate 2C facing away from the medium 2B. The quarter-wave plate 3 has its fast phase axis in the direction that forms an angle of 45 degrees with respect to the X-axis and the Y-axis. The Z-axis is taken in the direction of light propagation, and the X-axis and the Y-axis are taken in a plane parallel to the hologram plane 2a. The refractive indices of the medium 2B in the x direction and the y direction are indicated as “nx” and “ny”, respectively. The refractive indices each are a function of the wavelength in practice, but the same value is used instead of actual values since the difference between them is small in the vicinity of a visible to infrared range. FIG. 6 shows the grating running along the Y-axis, but it may run in any direction. Furthermore, outgoing lights 12a (lights traveling from the light source 1 toward the polarization hologram 2) emitted from the respective emission points are polarized in the Y direction.

The following formulae should hold with respect to the depth d of the grating and the respective refractive indices.

(na−ny)d=Nλ1 Formula 12

(na−nx)d=nλ1+λ1/2 Formula 13

In the above formulae, N denotes an integral number other than zero, and n indicates an integral number.

In the case of the polarization holograms in the conventional example and Embodiment 1, N=0, but the present embodiment is characterized in that N≠0.

First, in the case of the light with the wavelength λ1, since the outgoing light 12a is polarized in the Y direction, a phase difference of Nλ1 (i.e. a phase difference of 2π) occurs between lights passing through a concavity and a convexity of the grating according to Formula 12 when the light is transmitted through the polarization hologram substrate 2. This phase difference is substantially identical to a phase difference of zero. Accordingly, the light 12b that has passed through the medium 2B is not diffracted by the grating. The polarization direction of the light 12b remains the same in the Y direction. The light 12b passes through the quarter-wave plate 3 to become circularly polarized light 12c. The returning light 13a coming from the optical disk signal plane 6a is the same circularly polarized light as the light 12c when the optical disk substrate 6 causes no double refraction. The returning light 13a becomes light 13b linearly polarized in the X direction by passing through the quarter-wave plate 3. Hence, according to Formula 13, a phase difference of nλ1+λ1/2 (i.e. a phase difference of π) occurs between lights passing through the concavity and the convexity of the grating when the light 13b is transmitted through the polarization hologram substrate 2. The light 13c that has passed through the substrate 2A has been diffracted considerably by the grating (about 0% in the case of zeroth-order light and about 41% in the case of the respective ±first-order lights).

Next, in the case of light with the wavelength λ2, since the outgoing light 12a is polarized in the Y direction, a phase difference of λ2−Nλ1 (i.e. a phase difference of 2π(1−Nλ1/λ2)) occurs between lights passing through the concavity and the convexity of the grating according to Formula 12 when the light is transmitted through the polarization hologram substrate 2. Generally, the light 12b that has passed through the medium 2B has been diffracted by the grating. However, the zeroth-order diffracted light alone is related to recording and reproduction of signals, and the other higher-order (first-order and higher) diffracted lights are stray light components that are subjected to elimination. Accordingly, the higher-order diffracted lights in the outgoing path are ignored in the following discussion. The polarization direction of the light 12b remains the same in the Y direction. The light 12b passes through the quarter-wave plate 3 (corresponding to a 1/4×λ1/λ2 wave plate for light with a wavelength λ2) to become elliptically polarized light 12c. The returning light 13a coming from the optical disk signal plane 6a′ conceivably may be circularly polarized light, elliptically polarized light, or linearly polarized light when the optical disk substrate 6′ causes double refraction. Accordingly, the direction in which the light 13b has been polarized by passing through the quarter-wave plate 3 should be considered to be any direction between the X direction and the Y direction. Thus, according to Formula 13, after the passage of light through the polarization hologram substrate 2, there exist both phase differences of λ2−nλ1−λ1/2 and λ2−Nλ1 (i.e. phase differences of 2π{1−(n+1/2)λ1/λ2} and 2π(1−Nλ1/λ2)) between lights passing through the concavity and the convexity of the grating. Generally, the light 13c that has passed through the substrate 2 has been diffracted by the grating, and the diffraction efficiency, therefore, cannot be zero under any birefringence conditions given for the optical disk substrate 6′. For instance, when λ1=660 nm, λ2=792 nm, N=1, and n=0, the diffraction efficiency for ±first-order lights in the outgoing path is about 10% (a phase difference: π/3) while both the phase differences of 7π/6 and π/3 exist in the returning path and in the former case, the diffraction efficiency for ±first-order lights is 38% and in the latter case, the diffraction efficiency is about 10%. That is, the diffraction efficiency varies between 10% and 38% according to the birefringence conditions. When λ1=660 nm, λ2=792 nm, N=1, and n=1, the diffraction efficiency for ±first-order lights in the outgoing path is about 10% (a phase difference: π/3) while both the phase differences of −π/2 and π/3 exist in the returning path and in the former case, the diffraction efficiency for ±first-order lights is 20% and in the latter case, the diffraction efficiency is about 10%. That is, the diffraction efficiency varies between 10% and 20% according to the birefringence conditions. In both the cases, the diffraction efficiency can never be lower than 10% under any birefringence conditions given for the optical disk substrate 6′. Consequently, an effect is obtained that optical disk signals can be detected by the photodetector reliably even in the case of optical disks having high birefringence such as CDs or the like. Accordingly, with respect to the light having the wavelength λ2, stable signal detection performance can be secured against the influence of birefringence of the optical disk substrate although the light transmission efficiency in the outgoing path and the photodetection efficiency in the returning path slightly deteriorate.

In the above description, the medium 2B shown in FIG. 6 is made of a birefringence material. The substrate 2A, however, may be formed of a birefringence material, or both the substrates 2A and the medium 2B may be formed of a birefringence material.

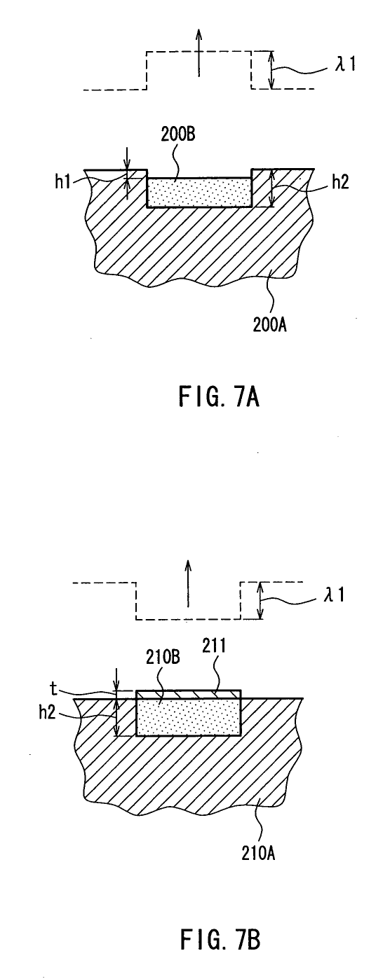

FIGS. 7A and 7B are cross-sectional views each showing a polarization hologram substrate 2 according to another example. In the polarization hologram substrate 2 shown in FIG. 7A, a proton exchange region 200B is formed in a LiNbO₃ crystal medium 200A by patterning and partial etching carried out thereafter. The proton exchange region 200B is formed in the Y-axis direction shown in FIG. 6, but may be formed in any direction.

Examples of the polarization hologram substrate 2 as shown in FIG. 7A include a polarization hologram substrate that has a proton exchange region 200B with a refractive index ne of 2.33 in the P-wave incident direction and a refractive index no of 2.24 in the S-wave incident direction, and a medium 200A with a refractive index ne of 2.20 in the P-wave incident direction and a refractive index no of 2.28 in the S-wave incident direction, wherein an etching depth h1 is 0.46 μm, and a proton exchange depth h2 is 2.1 μm.

In the polarization hologram substrate 2 shown in FIG. 7B, a proton exchange region 210B is formed in a LiNbO₃ crystal medium 210A by patterning, and further a Ta₂O₃ film is formed thereon by patterning. The proton exchange region 210B is formed in the Y axis direction shown in FIG. 6, but may be formed in any direction.

Examples of the polarization hologram substrate 2 shown in FIG. 7B include a polarization hologram substrate that has a medium 210A and a proton exchange region 210B both of which have the same refractive indices as those in the above-mentioned example of the polarization hologram substrate 2 shown in FIG. 7A, and a Ta₂O₃ film having a refractive index n of 2.10 and a thickness t of 0.30 μm, wherein a proton exchange depth h2 is 2.1 μm.

In FIGS. 7A and 7B, the broken lines indicate the transmission wave-front in the case where light with a wavelength λ1 (0.66 μm) is transmitted through the polarization hologram substrate 2 and thereby a phase difference λ1 is caused but is equal to a phase difference of substantially zero. With respect to the aspects other than this, the effect of the polarization hologram substrates 2 shown in the respective drawings is the same as that obtained in the polarization hologram substrate shown in FIG. 6. Accordingly, with respect to both light with the wavelength λ1 and light with the wavelength λ2, adequate diffraction efficiency can be obtained reliably.

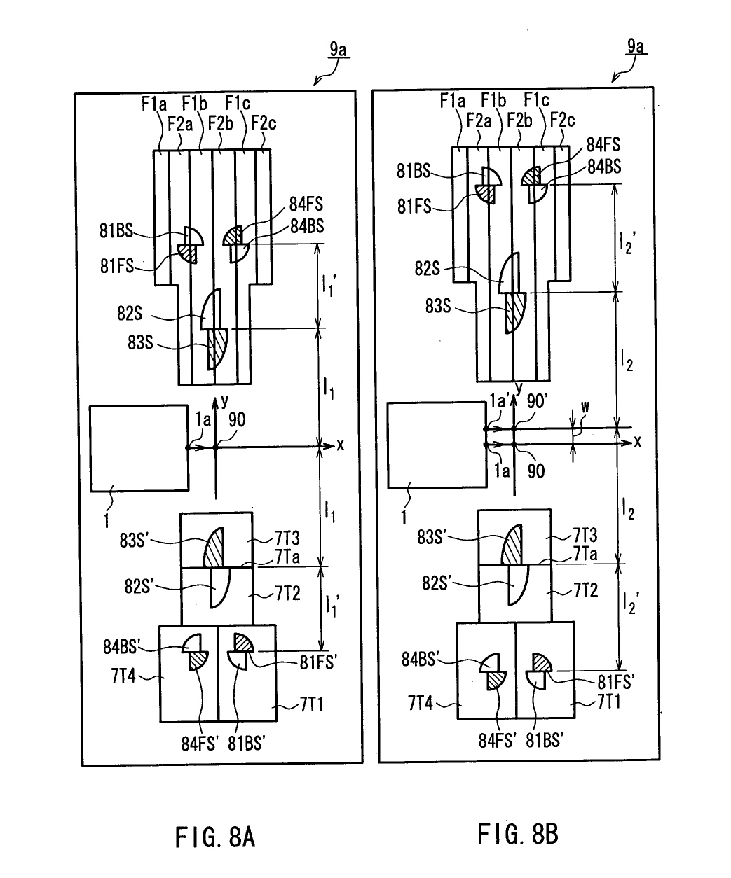

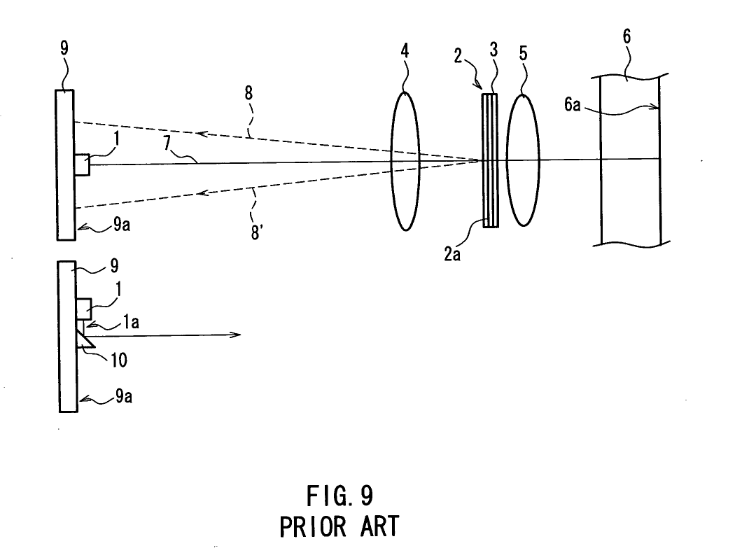

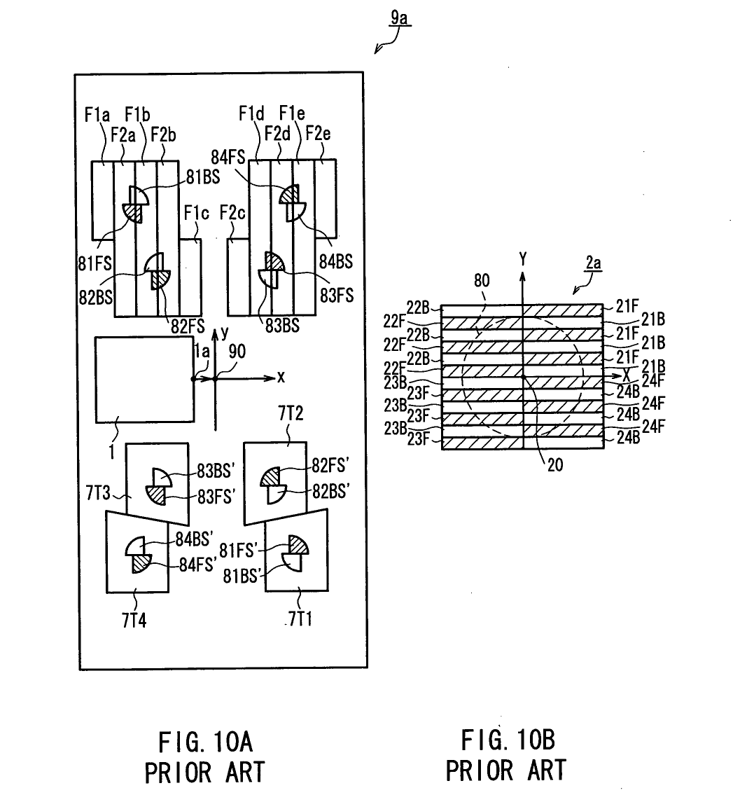

FIGS. 8A and 8B each show a photodetection pattern and the manner of light distributed thereon according to Embodiment 3, which are views obtained when the hologram plane side is seen from the optical disk side. The hologram pattern and the positions of focal points before and behind the photodetector in the cross-section taken along the optical axis are the same as those in Embodiment 1 and their description, therefore, is omitted here. The photodetection pattern also is the same as that in Embodiment 1 except for its shape expanded in the y direction, and its description also is omitted here. FIG. 8A shows the manner of light spots formed by returning light with respect to the first laser beam emitted from the first emission point 1a, while FIG. 8B shows the manner of light spots formed by returning light with respect to the second laser beam emitted from the second emission point 1a′.

In FIG. 8A, the joint between light spots 82S′ and 83S′ is located at a distance of l1 from the point 90 when it is measured in the y-axis direction (the same holds true with respect to the joint between light spots 82S and 83S). The joint between light spots 81FS′ and 81BS′ and the joint between light spots 84FS′ and 84BS′ each are located at a distance of l1+l1′ from the point 90 when it is measured in the y-axis direction (the same holds true with respect to the joint between light spots 81FS and 81BS and the joint between light spots 84FS and 84BS). On the other hand, in FIG. 8B, the joint between light spots 82S′ and 83S′ is located at a distance of l2 from the point 90′ when it is measured in the y-axis direction (the same holds true with respect to the joint between light spots 82S and 83S). The joint between light spots 81FS′ and 81BS′ and the joint between light spots 84FS′ and 84BS′ each are located at a distance of l2+l2′ from the point 90′ when it is measured in the y-axis direction (the same holds true with respect to the joint between light spots 81FS and 81BS and the joint between light spots 84FS and 84BS). The emission points 1a and 1a′, i.e. the point 90 and the point 90′, are located at a distance ε from each other along the y-axis. Here, let us suppose the following relationship holds.

l2=l1+ε Formula 14

In this case, if the joint between the light spots 82S′ and 83S′ approximately coincides with the parting line 7Ta between the photodetectors 7T2 and 7T3 with respect to the first laser beam, the same holds true with respect to the second laser beam.

On the other hand, the distance from the virtual emission point (i.e. points 90 or 90′) is approximately proportional to the angle of diffraction, and the angle of diffraction is approximately proportional to the wavelength. Accordingly, the following formula holds.

l2/1=l2′/l1′=λ2/λ1 Formula 15

For example, when λ1=660 nm, λ2=792 nm, and ε=100 μm, l1=500 μm and l2=600 μm.

Since the photodetection pattern of the present embodiment has a shape extending in the y direction, the light spots 81FS′ and 81BS′ and the light spots 84FS′ and 84BS′ are formed within the photodetectors 7T1 and 7T4, respectively, even when they are formed by lights with different wavelengths. Moreover, the light spots 82S and 83S, the Light spots 81FS and 81BS, and light spots 84FS and 84BS have narrow widths in the x-axis direction and are arranged substantially along the y-axis. They merely shift along the y-axis even when they are formed by lights with different wavelengths, which does not have much effect on FE signals.

Consequently, while excellent FE signal characteristics are maintained with respect to two laser beams, the same effect as that obtained in Embodiment 1 can be obtained by the same principle as in Embodiment 1 with respect to the deviation of the objective lens 5 and the polarization hologram substrate 2 in the radial direction.

As described above, according to the present invention, even if the objective lens and the polarization hologram substrate deviate in the radial direction of the optical disk, off-track that occurs under the tracking control can be cancelled. Furthermore, in the configuration with two adjacent radiation light sources, control signals and reproduction signals are detected by the same photodetector, and off-track that occurs under the tracking control can be cancelled. Particularly, with respect to one light source, the diffraction efficiency can never be zero under any birefringence conditions given for the optical disk substrate, and thereby optical disk signals can be detected reliably.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical disk device, comprising a radiation light source, an objective lens, an optical splitter, and a photodetector,
wherein light emitted from the radiation light source passes through the objective lens to be focused on a signal plane of an optical disk;
light reflected by the signal plane passes through the objective lens to enter the optical splitter;
the optical splitter is divided into four quadrants Ak (wherein k=1, 2, 3, 4) by two straight lines (a y-axis parallel with an optical disk radial direction and an x-axis orthogonal thereto) that intersect with an optical axis;
the photodetector is divided into at least four regions Bk;
first-order diffracted lights ak are derived from light that has entered the quadrants Ak by the optical splitter and are projected on the regions Bk of the photodetector, respectively;
sections of the first-order diffracted lights a2 and a3 taken along the x-axis lie approximately on a boundary between the regions B2 and B3; and
the first-order diffracted lights al and a4 are distributed on the photodetector apart from each other.

2. The optical disk device according to claim 1, wherein a tracking error signal TE with respect to the optical disk is generated according to a formula of TE=C1−C4−(C2−C3)/m, where Ck denotes a signal detected in the region Bk (wherein k=1, 2, 3, or 4), and m indicates a value of 1 or higher.

3. The optical disk device according to claim 1, wherein minus first-order diffracted lights ak′(wherein k=1, 2, 3, 4) are derived from light that has entered the quadrants Ak by the optical splitter, the minus first-order diffracted light a2′ is focused on a detection plane without being inverted with respect to a substantial y-axis direction, and the minus first-order diffracted light a3′ is inverted with respect to the substantial y-axis direction to be focused on the detection plane.

4. An optical disk device, comprising a first radiation light source, a second radiation light source, an objective lens, an optical splitter, and a photodetector,
wherein the first and second radiation light sources are disposed on the photodetector;
light emitted from the first radiation light source passes through the objective lens to be focused on a signal plane of a first optical disk;
light reflected by the signal plane passes through the objective lens to enter the optical splitter;
the optical splitter is divided into four quadrants Ak (wherein k=1, 2, 3, 4) by two straight lines (y-axis parallel with an optical disk radial direction and an x-axis orthogonal thereto) that intersect with an optical axis;
the photodetector is divided into at least four regions Bk;
first-order diffracted lights ak are derived from light that has entered the quadrants Ak by the optical splitter and are projected on the regions Bk of the photodetector, respectively;
light that is emitted from the second radiation light source and has a different wavelength from that of the light emitted from the first radiation light source passes through the objective lens to be focused on a signal plane of a second optical disk; and
light reflected by the signal plane of the second optical disk passes through the objective lens to enter the optical splitter, and first-order diffracted lights bk are derived from light that has entered the quadrants Ak by the optical splitter and are projected on the regions Bk of the photodetector, respectively.

5. The optical disk device according to claim 4, wherein sections of the first-order diffracted lights a2 and a3, or b2 and b3 taken along the x-axis lie approximately on a boundary between the regions B2 and B3, and the first-order diffracted lights a1 and a4, or b1 and b4 are distributed on the photodetector apart from each other.

6. The optical disk device according to claim 4, wherein a tracking error signal TE with respect to the first or second optical disk is generated according to a formula of TE=C1−C4−(C2−C3)/m, where Ck denotes a signal detected in the region Bk (wherein k=1, 2, 3, or 4), and m indicates a value of 1 or higher.

7. The optical disk device according to claim 4, wherein minus first-order diffracted lights ak′ or bk′(wherein k=1, 2, 3, 4) are derived from light that has entered the quadrants Ak by the optical splitter, the minus first-order diffracted light a2′ or b2′ is focused on a detection plane without being inverted with respect to a substantial y-axis direction, and the minus first-order diffracted light a3′ or b3′ is inverted with respect to the substantial y-axis direction to be focused on the detection plane.

8. An optical disk device, comprising a first radiation light source, a second radiation light source, an objective lens, an optical splitter, and a photodetector,
wherein the optical splitter has a configuration with a birefringent medium having a periodic concave-convex cross-section;
light having a wavelength λ1 emitted from the first radiation light source enters the optical splitter to be converted into light having a phase difference of about 2nπ (where n is an integral number other than zero) periodically;
the light passes through the objective lens to be focused on a signal plane of a first optical disk;
light reflected by the signal plane passes through the objective lens and then enters the optical splitter to be converted into light having a phase difference of about 2nπ+α (where α denotes a real number other than zero) periodically, and diffracted light derived from the light enters the photodetector to be detected;
light having a wavelength λ2 emitted from the second radiation light source enters the optical splitter to be converted into light having a phase difference of about 2nπλ1/λ2 periodically;
the light passes through the objective lens to be focused on a signal plane of a second optical disk;
light reflected by the signal plane of the second optical disk passes through the objective lens and then enters the optical splitter to be converted into light having a phase difference of about (2nπ+α)λ1/λ2 periodically; and
diffracted light derived from the light enters the photodetector to be detected.

9. An optical splitting device, comprising a first radiation light source, a second radiation light source, an objective lens, an optical splitter, and a photodetector,
wherein the optical splitter has a configuration with a birefringent medium having a periodic concave-convex cross-section;
light having a wavelength λ1 emitted from the first radiation light source enters the optical splitter to be converted into light having a phase difference of about 2nπ (where n is an integral number other than zero) periodically;
the light passes through the objective lens to be focused on a signal plane of a first optical disk;
light reflected by the signal plane passes through the objective lens and then enters the optical splitter to be converted into light having a phase difference of about 2nπ+α (where α denotes a real number other than zero) periodically, and diffracted light derived from the light enters the photodetector to be detected;
light having a wavelength λ2 emitted from the second radiation light source enters the optical splitter to be converted into light having a phase difference of about 2nπλ1/λ2 periodically;
the light passes through the objective lens to be focused on a signal plane of a second optical disk;
light reflected by the signal plane of the second optical disk passes through the objective lens and then enters the optical splitter to be converted into light having a phase difference of about (2nπ+α)λ1/λ2 periodically; and
diffracted light derived from the light enters the photodetector to be detected.
